(19) United States
(12) Patent Application Publication
(10) Pub. No.: US 2009/0212090 A1
(43) Pub. Date: Aug. 27, 2009

(54) Industrial welding system

(76) Inventors: Franz Hepp, Dettingen (DE); Tobias Schuler, Reutlingen (DE); Thomas Schedding, Reutlingen (DE)

Correspondence Address: K.F. ROSS P.C., 5683 RIVERDALE AVENUE, SUITE 203 BOX 900, BRONX, NY, 10471-0900, US

(21) Appl. No.: 11/920,989

(22) PCT Filed: Mar. 25, 2006
(86) PCT No.: PCT/EP2006/002767

§ 371 Date: Jan. 31, 2009

(30) Foreign Application Priority Data
Mar. 25, 2006 (DE) 2005 019 688.8

(51) Int. Cl. B23K 37/04

(52) U.S. Cl. 228/47.1

(57) ABSTRACT

The invention relates to an industrial welding system with a tool table, which has at least one tool holder for fixing workpieces that are to be welded. According to the invention, the tool holder is placed on a rotating frame that is mounted in a manner that enables it to rotate about a rotation axis that is parallel to a table base area of the tool table. The invention serves to weld plastic parts for the automotive industry.

The invention relates to an industrial welding system with a work table that has at least one tool holder for securing workpieces to be welded.

Industrial welding systems, in particular those serving for welding thermoplastic resin parts, are known. Ultrasonic and heating-element welders are known for this purpose. Such welders are particularly effective at the industrial welding of thermoplastic resin parts, in particular fuel tanks. The known welders each have a work table that can pivot or move in a straight line and that has at least one tool holder. The tool holder grips the plastic part to be welded. The tool itself is a clamp. When several workpieces have to be welded together by the welding system, the clamp must be removed and a new clamp mounted. The unneeded clamps are stored apart.

It is an object of this invention to provide an industrial welding system of the above-described type that allows optimally efficient operation.

This object is attained in that the tool holder is mounted on a pivotal mount that can pivot about an axis parallel to the support face of the work table. Preferably the support face is horizontal. The work table is preferably movable and has at least two different tool holders so that two workpieces can be secured in place at the same time. The movable arrangement of the work table makes it possible to selectively position each of the workpieces with regard to the appropriate welding station of the industrial welding system. The solution according to the invention is particularly effective with heating-element welders or friction-type welders, and is equally usable with an ultrasonic welder. The work table is preferably movable along a straight line and/or rotatable about a vertical axis. The pivotal mount can on one side have a tool holder and on the other side a counterweight.

Alternatively the pivotal mount can have a tool holder on each side so that the pivotal mount can be usable as a changeable or indexable tool. The pivoting of the pivotal mount and also of the one or more tool holders makes it possible to optimally position the respective workpieces with respective to the respective welding element, the position of the pivotal mount preferably being changed during the welding operation. This way it is possible to make complexly shaped welds by appropriate pivoting of the pivotal mount with the resultant movement of the welding element.

In an embodiment of the invention the pivotal mount has a drive that pivots it. This way it is possible to control angular movement of the pivotal mount. Such a drive can for example have an electric motor, or a pneumatic or hydraulic or hybrid actuator.

Another embodiment of the invention provides for controllers that operate the drive device and/or lock the pivotal mount in defined rotational positions. Therefore, the controllers serve either as drive control of as a latch or also, in combination, both as controller of the rotary movement of the pivotal mount in addition to blocking or locking the pivotal mount. In the latter case, the locking or blocking occurs especially through a suitable embodiment of the drive device whereby it especially is equipped with a braking device.

In another embodiment of the invention, the pivotal mount is rotatable between two positions angularly offset by 180° to each other, and the pivotal mounts are equipped on opposite sides with respective tool holders. In this embodiment, the pivotal mount has the function of a turnable or indexable tool where two similar or different tools are mounted on the opposite sides of the pivotal mount. Depending on which tool is required for a particular work process, the respective tool is rotated into its upper function position, while the other tool thereby inevitably is moved to the lower nonuse position.

In another embodiment of the invention, the controller comprises a control unit that is connected with the central controller of the welding system in such a manner as to effect a rotation of the pivotal mount in accordance with the corresponding work processes of the welding system.

Thereby it is possible to control the welding system including the work table and at least one pivotal mount fully automatically.

In another embodiment of the system, the work table is positioned for rotation about an upright axis like a carousel. The upright axis is preferably exactly vertical. Especially for heat-element welding systems, a rotary table type function of the work table is preferred.

In another embodiment of the invention, the work table is positioned horizontally so that it can travel in a straight line. This type of embodiment may be applied advantageously for ultrasonic welding systems.

Additional advantages and features of the invention may be derived from the claims, in addition to the following description of examples of preferred embodiments of the invention that are shown in the illustrations.

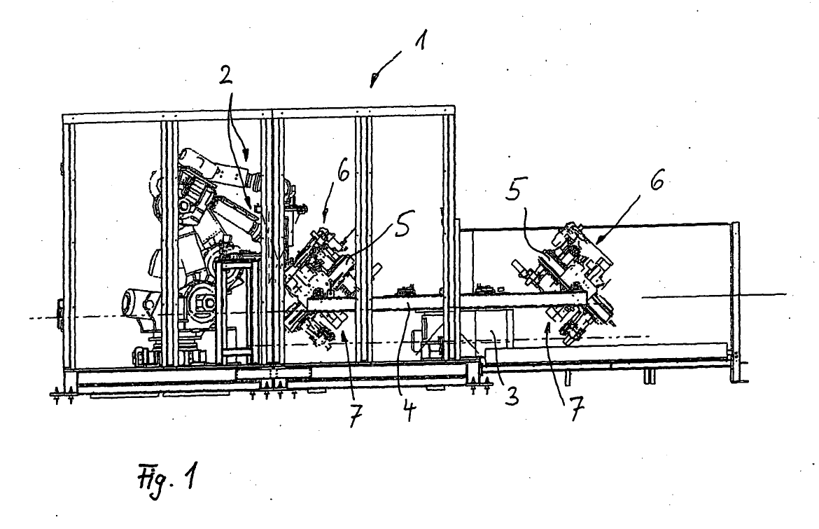

FIG. 1 is a side view of an embodiment of an industrial welding system in accordance with the invention that is a laser welder,

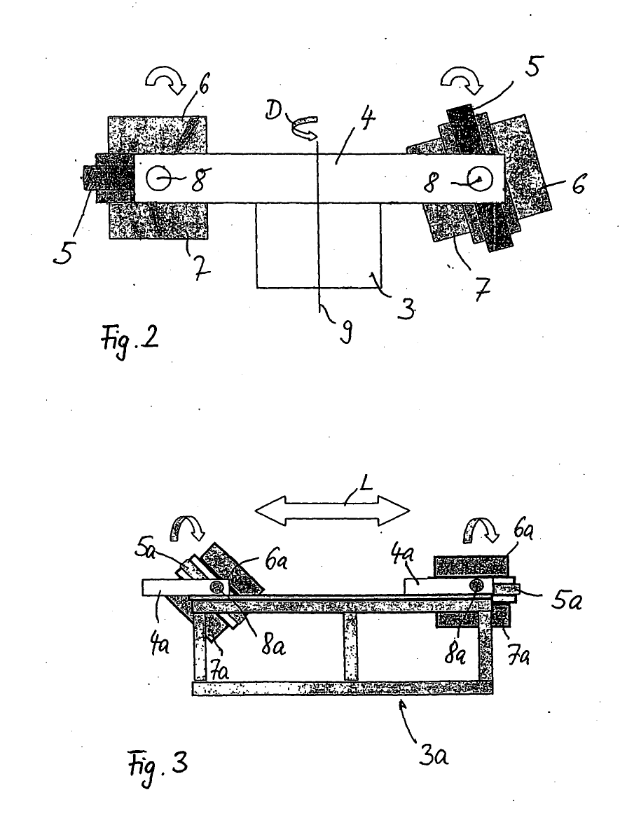

FIG. 2 is an enlarged schematic illustration of a work table for a laser welder according to FIG. 1, and

FIG. 3 is a schematic view of another work table for an industrial welding system that is formed such that it can travel in a straight line.

An industrial welding system 1 according to FIG. 1 of the heating-element type is equipped with welding robots 2. The welding robots 2 serve for welding together workpieces, in this case of thermoplastic resin parts, that are held by tool holders 6 and 7. Work tables 3 and 4, which have a tool support 4 and a table base 3, carry the tool holders 6 and 7. The table base 3 is pivotable about a vertical axis [9]. The tool support 4 is rotated jointly with the table base 3 and can also move horizontally in a straight line. In the schematic illustration of FIG. 2, this additional straight-line shifting of the tool support 4 is not shown. Rather, in the schematic showing of FIG. 2, the tool support 4 is fixed to the table base 3. As in FIG. 1, the table base 3 is pivotable a vertical axis 9 in the direction of arrow D.

Each of the two opposite outer ends of the tool support 4 carries a respective pivotal mount 5 for rotation around a respective horizontal axis extending transversely across a longitudinal axis of the tool support 4. To this end, the tool support 4 is shaped like a fork on its opposite ends so that the pivotal mounts 5 are each flanked by two holder extensions that receive a pivot 8 of the respective pivotal mount 5.

The pivotal mounts 5 are equipped both on their tops and bottoms with tool holders that carry tools 6 and 7 for holding respective workpieces.

Each pivotal mount 5 is rotated in a manner that is not illustrated more specifically by a drive in the form of an electric motor, or a hydraulic or pneumatic actuator. The drive is operated in a manner not more specifically illustrated by controllers that are part of the central controller of the industrial welding system 1. The table base 3 is equipped with a rotary table drive in a manner that is also not more specifically illustrated. Moreover, according to FIG. 1, the straight-line-movable tool support 4 is equipped with an additional straight-line actuator that enables the tool support 4 to travel horizontally. The rotary table drive and the straight-line drive for the tool support 4 are also operated by a central controller in order to permit a fully automatic operation of the laser welding system 1. The laser-welding robots 2 can also be operated by the central controller in order to enable a corresponding positioning and welding function relative to the corresponding workpiece. The controllers can rotate each pivotal mount 5 into any desired rotational position and can be hold it in each position. In a particularly advantageous manner, the controllers are built in a way that each pivotal mount 5 can be rotated from a horizontal functional position according to FIG. 2 (left pivotal mount 5) by 180°, so that the tool 7 that in FIG. 2 is directed downward, is directed upward, and the tool that in FIG. 2 is positioned above, can be moved underneath. This way it becomes possible to change tools in a simple manner without having to dissemble or assemble the respective tools 6 or 7. In addition, the rotary table and/or the table base 3 can also be rotated by 180° in a horizontal rotational plane, so that the opposite pivotal mount 5 with its corresponding tools can also be rotated toward the welding station. This rotation shifts the other pivotal mount 5 is out of the welding station. Thus it is possible, in embodiments according to FIG. 1 and 2, to move a total of four different tools into a welding position through simple rotational movements of the work table and/or the pivotal mount 5, without needing to load or unload the tools.

In the embodiment according to FIG. 3, the tool supports 4a are mounted on a table base 3a horizontally and can move in a straight line the direction of arrow L. Each tool support 4a is equipped with a pivotal mount 5a that can rotate relative to the corresponding tool support 4a around a horizontal pivot axis. Each pivotal mount 5a corresponds to the embodiment according to FIG. 2 and is equipped on its upper and lower sides with respective tools 6a and 7a. In the embodiment according to FIG. 3, components with the same function have been given the same reference numbers as the components in the embodiment according to FIG. 2, except with the addition of the letter “a”. The table base 3a may be mounted either in a stationary manner on the floor or rotatably around a vertical axis. This depends on where the actual welding elements of the industrial welding system are provided. If the welding elements are mounted in such a manner that a simple straight-line movement of the tool carriers 4a and a complementary rotary movement of the pivotal mounts 5a can move each of the tools 6a and 7a of both pivotal mounts 5a into the corresponding welding station and thus to the welding elements, the table base 3a is preferably mounted in a stationary manner, and only the tool carriers 4a are mounted in a straight-line-movable manner relative to the table base 3a.

According to embodiments that are not shown, that in terms of their basic concept are intended to be similar or identical to the embodiment according to FIG. 1, a table base 3a according to FIG. 3 is additionally positioned in a rotatable manner around a vertical axis. In the embodiment according to FIG. 3 or in embodiments that are not shown, suitable drive and controllers are also provided for, in order to make possible a fully automatic function of all movements of the industrial welding system.

According to embodiments that are not shown, manual rotation of the pivotal mount 5 may also be provided for. With such a manual rotation, the pivotal mounts 5 can preferably be blocked in their horizontal position by mechanical latches that are preferably manually releasable.

The operation by the controllers and from the central controller takes place through preset control parameters. It is also possible to control them with closed control circuits. For such an embodiment, the movable parts of the industrial welding system are provided with appropriate corresponding sensory systems that transmit to the central controller signals and data about instantaneous positions, angular positions, travel paths and similar items. The central controller is preferably equipped with data-storage devices and corresponding data-processing programs in order to enable the desired rotation of the individual drives with the help of set points and actual values.

1. An industrial welding system with a work table comprising at least one tool holder for securing workpieces to be welded wherein the tool holder is mounted on a pivotal mount that is rotatable about an axis that is parallel to a support face of the work table.

2. The industrial welding system according to claim 1 wherein the pivotal mount is equipped with a drive that can pivot the pivotal mount.

3. The industrial welding systems according to claim 2 wherein controllers are provided that move the drive or arrest the pivotal mounts in defined rotary positions.

4. The industrial welding system according to claim 1 wherein the pivotal mounts are pivotable between two rotary positions angularly offset by 180°, and the pivotal mounts are each provided on opposite sides with respective tool holders.

5. The industrial welding system according to claim 3 wherein the controllers comprise a control unit that is connected to a central controller of the welding system so as to pivot the pivotal mounts in accordance with the corresponding work processes of the welding system.

6. The industrial welding system according to claim 1 wherein the work tables are pivotable like a carousel about an upright axis.

7. The industrial welding system according to claim 1 wherein the work tables are positioned so that they can travel in a straight line horizontally.

8. (canceled)

9. An industrial welding system comprising:
at least one fixedly mounted welding robot defining a welding station;
a tool support pivotal about a fixed upright axis offset from the robot and having at least two ends similarly radially spaced from the axis and shiftable on pivoting of the support past the station;
respective mounts pivotal on the ends about respective horizontal axes and each having a pair of opposite faces;
means for securing respective workpieces to the faces; and
control means connected to the support and mounts for orbiting the mounts past the station with one of the workpieces on one of the mounts oriented for work by the robot, and for pivoting the one mount about its horizontal axis for positioning the other workpiece of the one mount for work by the robot.

10. The industrial welding system defined in claim 9 wherein the means are respective workpiece clamps.

11. The industrial welding system defined in claim 9 wherein the support is elongated and extends horizontally diametrally across the vertical axis.

12. The industrial welding system defined in claim 11 wherein the outer ends of the support are forked and the horizontal axes are parallel to each other and radially equispaced from the vertical axis.
